(19) United States
(12) Patent Application Publication
(10) Pub. No.: US 2009/0125344 A1
(43) Pub. Date: May 14, 2009

(54) SYSTEM AND METHOD FOR FUSION BETWEEN INCOMPATIBLE DATA MODELS

(76) Inventor: Stefan Kienzle, St. Leon-Rot (DE)

Correspondence Address: SAP AG, 3410 HILLVIEW AVENUE, PALO ALTO, CA, 94304, US

(21) Appl. No.: 11/938,310

(22) Filed: Nov. 12, 2007

(51) Int. Cl. G06Q 10/00; G06F 17/30; G06F 17/40

(52) U.S. Cl. 705/7; 707/100

(57) ABSTRACT

Disclosed is a system and a method for fusion between incompatible data models. The system generates a product data structure of a first data model and a product data structure of a second data model. Using a business Add-in method, this product data structure of the first data model is fused to the second data model to generate a fused product data structure of the second data model. An output controller is provided to output this fused product data structure of the second data model, thus making functions of first data model available in the second data model.

### FIELD OF THE INVENTION

The invention generally relates to system and method for data processing system. More particularly, the invention relates to systems and methods for allowing runtime cross communication between these different data models.

### BACKGROUND OF THE INVENTION

Computers have since long assisted and aided manufacturing. Several organizations have implemented software solutions on these computers to optimize their productivity and improve their efficiency. Some organizations have implemented such software solutions and over the years the complexity of such implementation has increased and there are several versions of the software that co-existing in parallel.

Typically, in the early years organizations implement a software system and later over the years the vendor release better and enhanced versions of software. Occasionally, during manufacturing a user using the new software system may need some features or information out of the old software system.

However, in the current system this requirement of making available old features or information requires additional coding or data migration. This activity introduces additional overhead costs and complexity of the system. This customization of software system requires several changes based on the customers business needs. Often this customization is very costly as it is time consuming, lots of repetitive tasks have to performed, and this effort is customer specific and not reusable. The cost of owning and maintaining such a software application is too expensive.

What is needed is a system and a method that allows for runtime fusion of between these two incompatible data models. The runtime fusion can greatly assists the maintenance and the deployment of such a system at runtime because the necessary business configuration settings and the customer-specific data will be directly maintained.

### SUMMARY OF THE INVENTION

Disclosed is a system and a method for fusion between incompatible data models. The system generates a product data structure of a first data model and a product data structure of a second data model. Using a business Add-in method, this product data structure of the first data model is fused to the second data model to generate a fused product data structure of the second data model. An output controller is provided to output this fused product data structure of the second data model, thus making functions of first data model available in the second data model.

### BRIEF DESCRIPTION OF THE DRAWINGS

Embodiments of the invention are illustrated by way of example, and not by way of limitation, in the FIG.s of the accompanying drawings in which like reference numerals refer to similar elements.

FIG. 1 is a diagram illustrating the operation of a supply chain management system having incompatible data models, according to an embodiment of the invention.

FIG. 2 is a diagram illustrating the runtime fusion between the incompatible data models, according to an embodiment of the invention.

FIG. 3 is a flow diagram illustrating the runtime fusion between the incompatible data models, according to an embodiment of the invention.

FIG. 4 is a flow diagram illustrating the runtime fusion between the incompatible data models, according to an embodiment of the invention.

FIG. 5 is a system block diagram of an implementation for generating the fact sheet, according to an embodiment of the invention.

### DETAILED DESCRIPTION

Disclosed is a system and a method for fusion between incompatible data models. The system generates a product data structure of a first data model and a product data structure of a second data model. Using a business Add-in method, this product data structure of the first data model is fused to the second data model to generate a fused product data structure of the second data model. An output controller is provided to output this fused product data structure of the second data model, thus making functions of first data model available in the second data model.

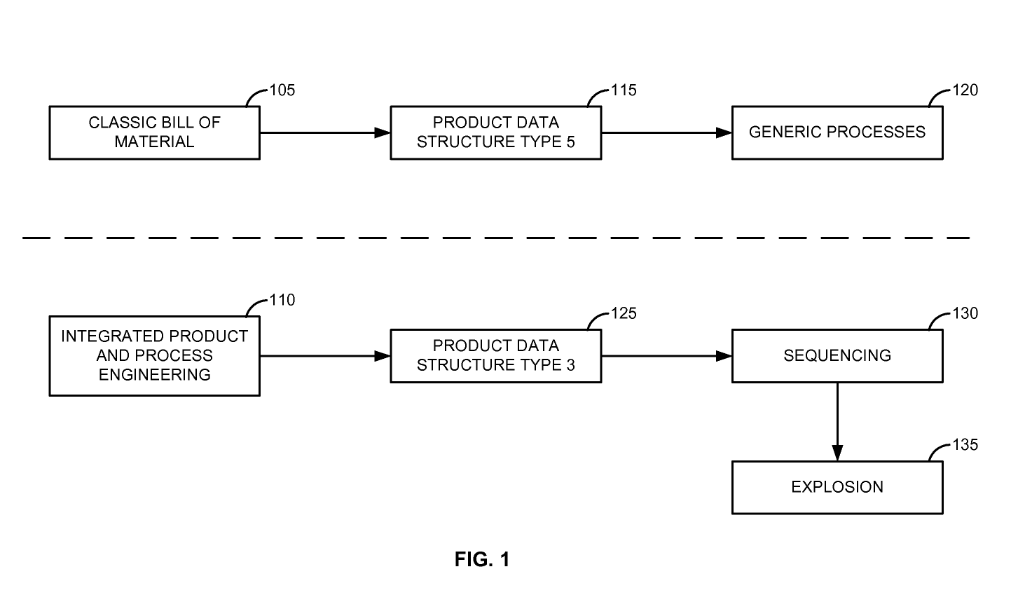

FIG. 1 is a diagram illustrating the operation of a supply chain management system having incompatible data models, according to an embodiment of the invention. In the earlier years of supply chain management software, few software vendors used the classic bill of material (BOM) 105 as a data model for master data management while later a few software vendors use the Integrated Product and Process Engineering (iPPE) 110 as a data model for master data management. A data model is a structure having name, quantity and unit of measure for each component. A comprehensive product life cycle management solution offers support for several categories of BOM. Today manufacturing industry is characterized by growing product diversity and ever shorter development cycles. One of the major challenges is to get to market faster by streamlining your product development and manufacturing start-up processes. The data models are used to generate the corresponding product data structure (PDS). While the classic BOM generates product data structure PDS type 5 115, this PDS is used by the generic processes 120 of the advanced data planning and optimization which is the planning module of supply chain management software. This streamlining can be achieved by performing a large number of tightly synchronizing processes in parallel, using a data model that contains all the information about the products and its variants and is accessible at every stage to all team members involved in development and production planning. The integrated product and process engineering (iPPE) 110 capabilities satisfy the specific needs in product development and production ramp-up in the industry. iPPE seamlessly integrates the processes and fosters concurrent product development and manufacturing planning using the PDS PDS Type 3 125. The sequencing 130 and the explosion 135 of the iPPE 110 helps narrows the gap between the engineering and design phases and manufacturing and thereby reducing the time to the market. iPPE 110 allows to document, track and manage information of the product at each stage in the development process. iPPE 110 provides a flexible system for managing status and final approval of the production process to make this information available as early as possible to everyone who needs it. As these data models classic BOM 105 and iPPE 110 are incompatible, existing classic customer cannot use iPPE 110 based functions with classic master data 105.

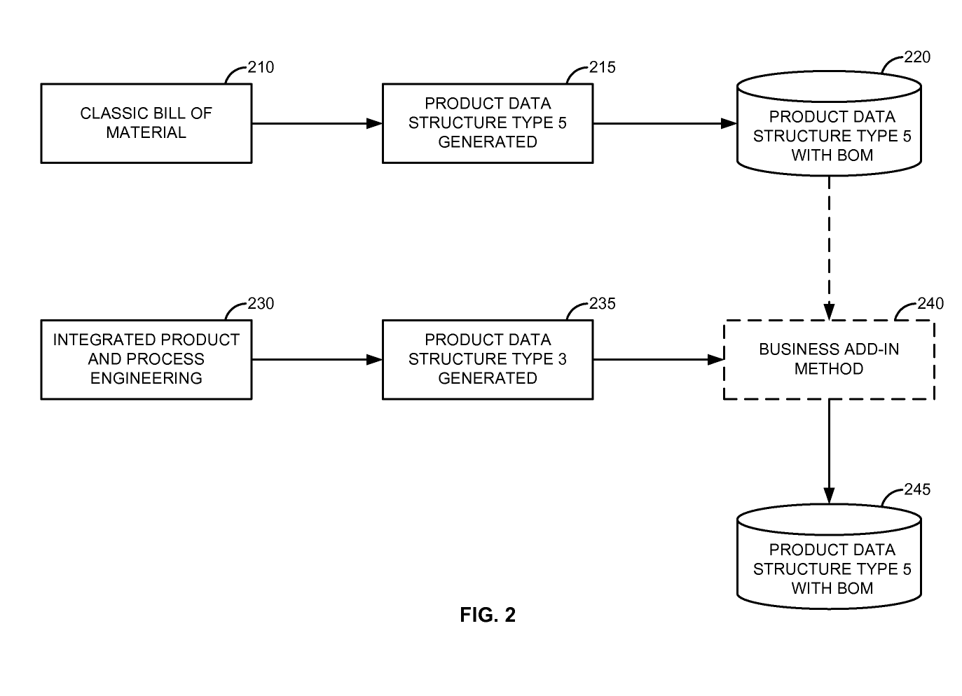

FIG. 2 is a diagram illustrating the runtime fusion between the incompatible data models according to an embodiment of the invention. The classic BOM 210 is one data model while iPPE 230 is the other incompatible data model. Classic BOM 210 data model is used to generate PDS type 5 215. This PDS is stored with BOM 220. While iPPE 230 data model generates PDS type 3 235. Using the Business Add-In Method (BADI) 240, PDS type 5 215 can be fused within PDS type 3 235 and the fused PDS can be persisted as enriched PDS type 3 with BOM 245. Thus the customer is able to use iPPE based functions within classic BOM master data.

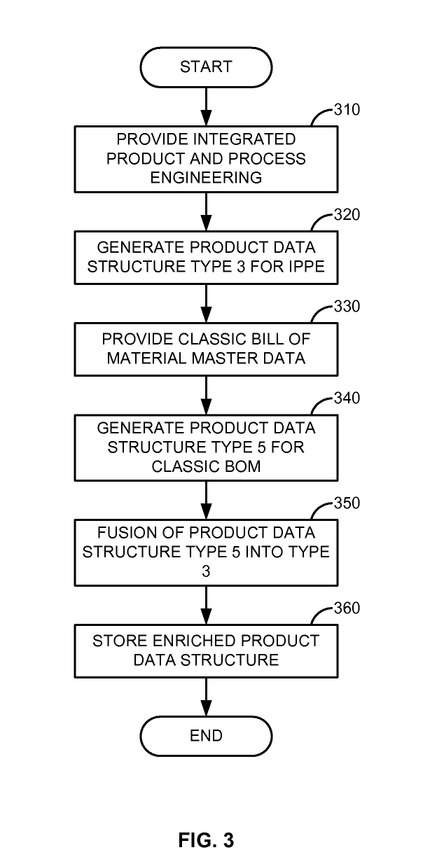

FIG. 3 is a flow diagram illustrating the runtime fusion between the incompatible data models, according to an embodiment of the invention. At 310, iPPE master data is provided. At 320, the system generates PDS type 3 for iPPE. At 330, a classic BOM master data is provided. At 340, the system generates PDS type 5 for classic BOM. At 350, business add-in method (BADI) can be used for fusion of both PDS type 3 for iPPE and PDS type 5 for classic BOM. At 360, the fused PDS obtained by fusing iPPE PDS and classic BOM PDS using the BADI is stored. This fused PDS is an enriched iPPE PDS with classic BOM PDS.

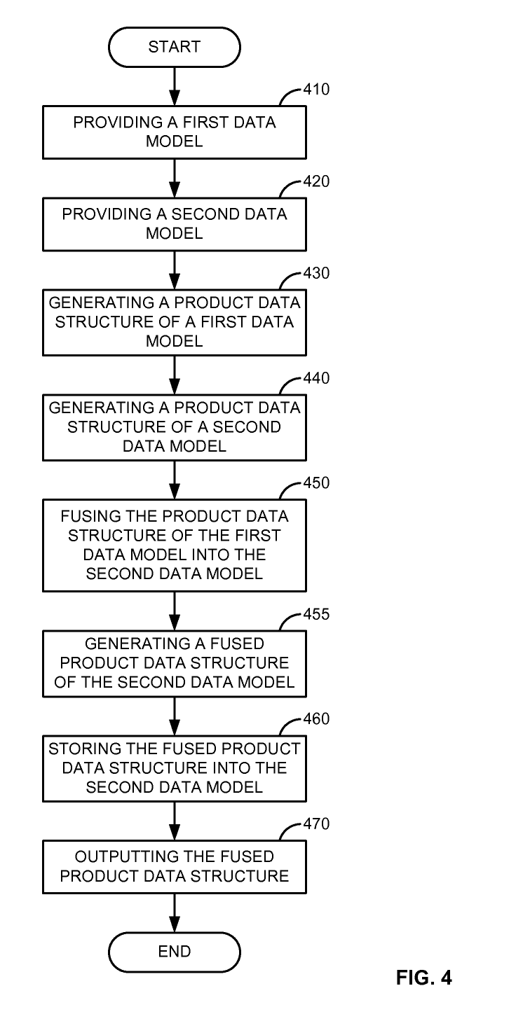

FIG. 4 is a flow diagram illustrating the runtime fusion between the incompatible data models, according to an embodiment of the invention. At 410, providing a first data model of the master data. At 420, providing a second data model of the master data. At 430, generating a PDS of the first data model. At 440, generating a PDS of a second data model. At 450, fusing the PDS of the first data model into the second data model. At 455, generating a fused product data structure of the second data model by fusing the product data structure of the first data model into the product data structure of the second data model. At 460, storing the fused PDS into the second data model. At 470, displaying the fused PDS of the second data model. In one embodiment of the invention, the first data model can be classic BOM while in yet another embodiment of the invention, the second data model can be iPPE.

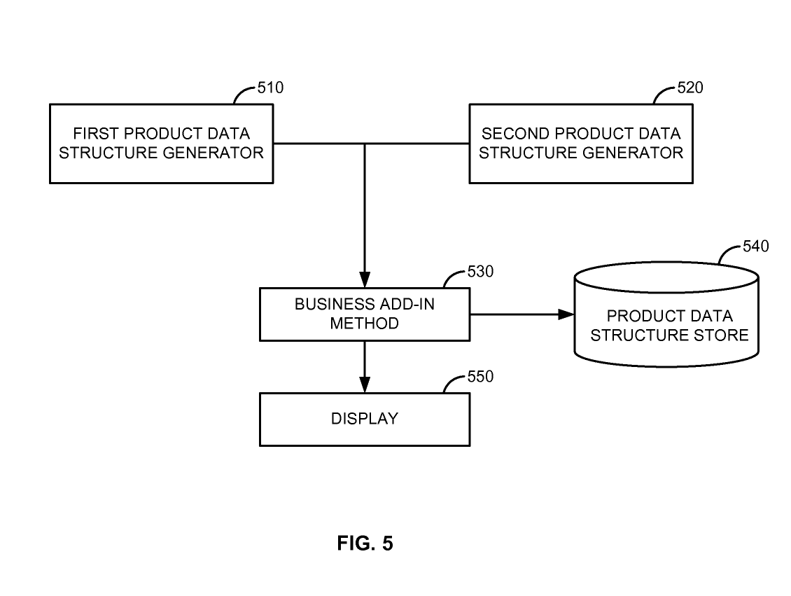

FIG. 5 is a system block diagram illustrating an implementation for runtime fusion of incompatible data models, according to an embodiment of the invention. A first PDS generator 510 generates the PDS of the first data model. A second PDS generator 520 generates the PDS of the second data model. A Business Add-in Method 530 allows for fusing these two PDS generated and the enriched PDS is stored in the PDS Store 540. Any suitable display 550 can be used to display the fused PDS.

Other embodiments of the invention may be implemented in digital electronic circuitry, or in computer hardware, firmware, software, or in combinations of them.

Elements of the invention may also be provided as a machine-readable medium for storing the machine-executable instructions. The machine-readable medium may include, but is not limited to, Flash memory, optical disks, CD-ROMs, DVD ROMs, RAMs, EPROMs, EEPROMs, magnetic or optical cards, propagation media or other type of machine-readable media suitable for storing electronic instructions.

Throughout the foregoing description, for the purposes of explanation, numerous specific details were set forth in order to provide a thorough understanding of the invention. It will be apparent, however, to one skilled in the art that the invention may be practiced without some of these specific details. The underlying principles of the invention may be employed using a virtually unlimited number of different types of input data and associated actions.

Accordingly, the scope and spirit of the invention should be judged in terms of the claims which follow.

What is claimed is:

1. A method for fusion between data models, comprising:
generating a product data structure by a CPU of a first data model;
generating a product data structure by the CPU of a second data model;
fusing the product data structure of the first data model into the product data structure of the second data model in a memory;
generating a fused product data structure of the second data model by fusing the product data structure of the first data model into the product data structure of the second data model by the CPU; and
outputting the fused product data structure of the second data model on a display unit.

2. The method of claim 1, further comprising receiving the first data model in the memory.

3. The method of claim 1, further comprising receiving the second data model in the memory.

4. The method of claim 1, wherein fusing the product data structure of the first data model into the product data structure of the second data model by the CPU comprises storing the fused product data structure into the product data structure store.

5. The method of claim 1, wherein the first data model in the memory comprises a bill of material master data.

6. The method of claim 1, wherein the second data model in the memory comprises integrated product and process engineering master data.

7. The method of claim 1, wherein fusing the product data structure of the first data model into the product data structure of the second data model by the CPU comprises fusing within a business add-in method.

8. The method of claim 7, further comprising calling the first product data structure directly into second product data structure within the business add-in method of the memory.

9. The method of claim 1, wherein displaying a fused product data structure of the second data model on a display unit comprises displaying components of the second data model.

10. A system, comprising:
a first product data structure data generator to generate a product data structure of a first data model;
a second product data structure generator to generate a product data structure of a second data model;
a business add-in method electronically coupled to the first product data structure generator and to the second data model product data structure generator to fuse the product data structure of the first data model into the product data structure of the second data model;
a product data structure store electronically coupled to the business add-in method, the product data structure to store the fused product data structure; and
an output controller electronically coupled to the business add-in method and to the product data structure store, to output the fused product data structure.

11. An article of manufacture, comprising:
a machine readable medium having instructions that when executed by a machine cause the machine to execute a method, comprising:
generating a product data structure of a first data model;
generating a product data structure of a second data model;
fusing the product data structure of the first data model into the product data structure of the second data model;
generating a fused product data structure of the second data model by fusing the product data structure of the first data model into the product data structure of the second data model; and
outputting the fused product data structure of the second data model.

12. The article of manufacture in claim 11, further comprising receiving the first data model.

13. The article of manufacture in claim 11, further comprising receiving the second data model.

14. The article of manufacture in claim 11, wherein fusing the product data structure of the first data model into the product data structure of the second data model comprises storing the fused product data structure in a product data structure store.

15. The article of manufacture in claim 11, wherein the first data model comprises a bill of material master data.

16. The article of manufacture in claim 11, wherein the second data model comprises integrated product and process engineering master data.

17. The article of manufacture in claim 11, wherein fusing the product data structure of the first data model into the product data structure of the second data model comprises fusing within a business add-in method.

18. The article of manufacture in claim 17, further comprising calling the first product data structure directly into second product data structure within the business add-in method.

19. The article of manufacture in claim 11, wherein displaying a fused product data structure of the second data model comprises displaying components of the second data model.
